(19) United States
(12) Patent Application Publication
(10) Pub. No.: US 2022/0192158 A1
(43) Pub. Date: Jun. 23, 2022

(54) Use of Aversive Stimulus Collars to Deter Physical Confrontations Between Livestock

(71) Applicant: Alexander Henry Dannenberg, NEWTON, MA (US)

(72) Inventor: Alexander Henry Dannenberg, NEWTON, MA (US)

(21) Appl. No.: 17/558,584

(22) Filed: Dec. 21, 2021

Related U.S. Application Data
(63) Continuation of application No. PCT/US21/64760, filed on Dec. 21, 2021.
(60) Provisional application No. 63/128,825, filed on Dec. 21, 2020.

(51) Int. Cl. A01K 27/00; A01K 15/02; A01K 29/00

(52) U.S. Cl. CPC A01K 27/009; A01K 29/005; A01K 15/02

(57) ABSTRACT

An aversive stimulus collar is configured for fitment around the necks of livestock to counter aggressive tendencies between animals. Each animal can be fitted with a collar that monitors for proximity of other similarly configured collars worn by other animals. When a collar worn by one animal senses that another collar worn by another animal is within a certain distance, the collar can deliver an aversive stimulus to the animal, such as an electric shock. As the distance between collared animals continues to decrease, the level, intensity, and/or frequency of the aversive stimulus can be increased so that the animal learns an association between proximity to other collared animals and the aversive stimulus.

### RELATED APPLICATIONS

The subject matter of this application is related to U.S. Provisional Application No. 63/128,825, filed on 2020 Dec. 21, which is hereby incorporated by reference in its entirety.

### BACKGROUND OF THE INVENTION

Livestock such as cattle and sheep are raised and maintained for various purposes, such as meat, milk, hides, and wool. Certain livestock, particularly males, such as bulls in the case of cattle, or rams in the case of sheep, have a tendency towards aggression towards each other. Aggression-related fighting between animals can result in significant injuries. The injuries themselves may be costly to treat, may be deadly or may be significant enough to necessitate slaughter of injured animals.

### SUMMARY OF THE INVENTION

An aversive stimulus collar is configured for fitment around the necks of livestock to counter aggressive tendencies between animals. Each animal can be fitted with a collar that monitors for proximity of other similarly configured collars worn by other animals. When a collar worn by one animal senses that another collar worn by another animal is within a certain distance, the collar can deliver an aversive stimulus to the animal, such as an electric shock. As the distance between collared animals continues to decrease, the level, intensity, and/or frequency of the aversive stimulus can be increased so that the animal learns an association between proximity to other collared animals and the aversive stimulus.

Benefits of the aversive stimulus collar can include decreased frequency of physical injury to livestock resulting from fights. Further, decreased aggression and deterrents from fighting between animals is expected to result in increased breeding and consequently increased production of offspring.

An aversive collar can include: a strap for securing the collar around an animal's neck; a proximity signal transmitter configured to wirelessly transmit a signal receivable by other aversive collars; a proximity signal receiver configured to receive signals wirelessly transmitted by proximity signal transmitters of other aversive collars; an aversive stimulus module configured to deliver an aversive stimulus to the animal; and control logic configured to: cause the proximity signal transmitter to transmit the signal receivable by other aversive collars, identify a signal received by the proximity signal receiver as a signal transmitted by an other aversive collar, process the received signal to determine that the other aversive collar is within a predetermined proximity, and in response to at least the determination that the other aversive collar is within a predetermined proximity, cause the aversive stimulus module to deliver an aversive stimulus to the animal.

The collar can be configured such that the signal received by the proximity signal receiver is identified as a signal transmitted by the other aversive collar based on data encoded into the received signal.

The collar can be configured such that the transmitted signal receivable by other aversive collars is encoded with data that distinguishes the aversive collar from other aversive collars.

The collar can be configured such that the proximity signal transmitter and the proximity signal receiver are integrated into a transceiver.

The collar can be configured such that the signal is a Wi-Fi signal or a Bluetooth signal.

The collar can further include: an inertial measurement unit; wherein the control unit is further configured to: monitor recent motion of the animal using the inertial measurement unit, and in response to at least the determination that the other aversive collar is within a predetermined proximity, cause the aversive stimulus module to deliver an aversive stimulus to the animal only if the recent motion of the animal satisfies one or more predefined criteria.

The collar can be configured such that the one or more predefined criteria include: the animal is in motion; the animal has recently initiated motion; and the animal has recently increased a rate of motion.

The collar can be configured such that the control unit is further configured to adjust a level of aversive stimulus delivered based on a level of proximity, wherein a minimum level of aversive stimulus is delivered at the predetermined proximity, and increased levels of aversive stimulus are delivered with increased proximity up to a maximum level of aversive stimulus.

The collar can further include: an inertial measurement unit; wherein the control unit is further configured to: monitor recent motion of the animal using the inertial measurement unit, and in response to at least a determination that the other aversive collar is becoming closer, cause the aversive stimulus module to deliver an increasing aversive stimulus to the animal only if the recent motion of the animal satisfies one or more predefined criteria.

The collar can be configured such that the one or more predefined criteria include: the animal is in motion; the animal has recently initiated motion; and the animal has recently increased a rate of motion.

The collar can further include: an inertial measurement unit; wherein the control unit is further configured to: monitor recent motion of the animal using the inertial measurement unit, and in response to at least a determination that the other aversive collar is not becoming closer, cause the aversive stimulus module to deliver a decreasing aversive stimulus to the animal only if the recent motion of the animal satisfies one or more predefined criteria.

The collar can be configured such that the one or more predefined criteria include: the animal is not in motion; the animal has recently ceased motion; and the animal has recently decreased a rate of motion.

The collar can be configured such that the predetermined proximity is determined based on signal strength of the received signal.

The collar can be configured such that the predetermined proximity is represented by a predetermined minimum signal strength of the received signal.

The collar can be configured such that the aversive stimulus module comprises an electric shock generator and delivery electrodes.

The collar can be configured such that the aversive stimulus module further comprises a sound signal generator and a speaker.

The collar can be configured such that the control logic is further configured to: first deliver an audible alarm aversive stimulus; and second, after a delay, deliver an electric shock aversive stimulus.

The collar can be configured such that the aversive stimulus comprises electric shocks, and a level of aversive stimulus is varied by changing one or more of voltage, duration, and frequency of the electric shocks.

The collar can be configured such that the aversive stimulus comprises audible signals, and a level of aversive stimulus is varied by changing one or more of duration, level, frequency, pitch, tone, and sound.

A system can include: a plurality of aversive collars fitted to a plurality of animals; and at least one of: a mobile device, carried by a human, wherein the mobile device is configured to transmit a signal that each aversive collar interprets as or in a same way as a signal transmitted by another aversive collar; and a transmitter collar fitted to a dog, wherein the transmitter collar is configured to transmit a signal that each aversive collar interprets as or in a same way as a signal transmitted by another aversive collar.

As will be appreciated by one skilled in the art, multiple aspects described in this summary can be variously combined in different operable embodiments. All such operable combinations, though they may not be explicitly set forth in the interest of efficiency, are specifically contemplated by this disclosure.

### BRIEF DESCRIPTION OF THE DRAWINGS

FIG. 1 illustrates a timeline of how two animals may receive aversive stimuli from their respective collars as their distance varies.

FIG. 2 illustrates an example graph of an example stimulus.

FIG. 3 illustrates a general diagram of an aversive collar in accordance with one embodiment.

FIG. 4 illustrates a component schematic of electronics of the collar in accordance with one embodiment.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

An aversive stimulus collar is configured for fitment around the necks of livestock to counter aggressive tendencies between animals. Each animal can be fitted with a collar that monitors for proximity of other similarly configured collars worn by other animals. When a collar worn by one animal senses that another collar worn by another animal is within a certain distance, the collar can deliver an aversive stimulus to the animal, such as an electric shock. As the distance between collared animals continues to decrease, the level, intensity, and/or frequency of the aversive stimulus can be increased so that the animal learns an association between proximity to other collared animals and the aversive stimulus.

The disclosed collar differs from other aversive collars in both its intended use and in the method used to trigger the aversive stimulus. For example, aversive collars for use in training dogs can be manually activated through a handheld wireless remote control. Aversive collars have also been used to restrict dogs to within a defined area, such that when a dog approaches an area boundary, an aversive stimulus is delivered. The boundary can be established, for example, using a buried wire that delivers a signal sensed by a dog's aversive stimulus collar. Alternatively, the collar can be configured to receive signals from a number of positioned transmitters (e.g. locally positioned transmitters or GPS). The collar can use the signals to determine its location, which the collar can compare to a map of boundaries stored in a memory in the collar to determine whether the dog is approaching or outside of a bounded area. Such collars deliver an aversive stimulus in either a discretionary, non-rules-based manner (manually activated collars) or in a rules-based manner in which all collars are activated by approach to a common, static position boundary. The disclosed collar, by contrast, utilizes peer-to-peer signaling to implement a dynamic, location-based rule that is different for each collar wearing animal.

In one embodiment, the disclosed collar can automatically deliver an aversive stimulus when a built-in sensor detects another collar that is closer than a predefined distance away. If animal A is too close to animal B then animal B is also too close to animal A, so both animals' collars will be triggered, and each will receive an aversive stimulus that will cause the animals to move apart.

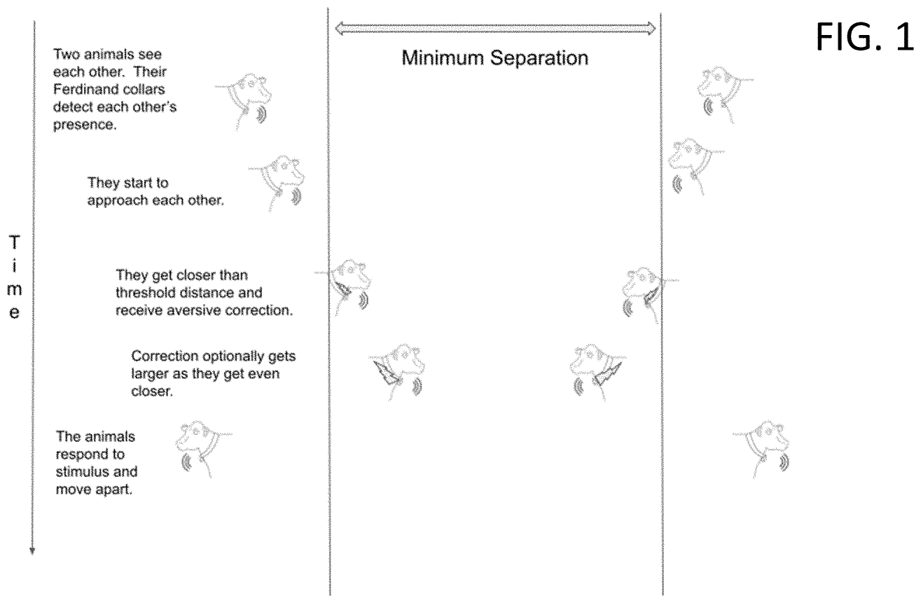

FIG. 1 illustrates a timeline of how two animals may receive aversive stimuli from their respective collars as their distance varies. The collar can, optionally, increase the aversive stimulus as the animals move even closer. In one embodiment, each collar can be configured to deliver a stimulus at a level or strength according to the following formula:

$$min ( \begin{matrix}maximum stimulus , \\ ( constant * max ( 0 , \frac{1}{distance between animals} - \frac{1}{threshold distance} ) )\end{matrix} )$$

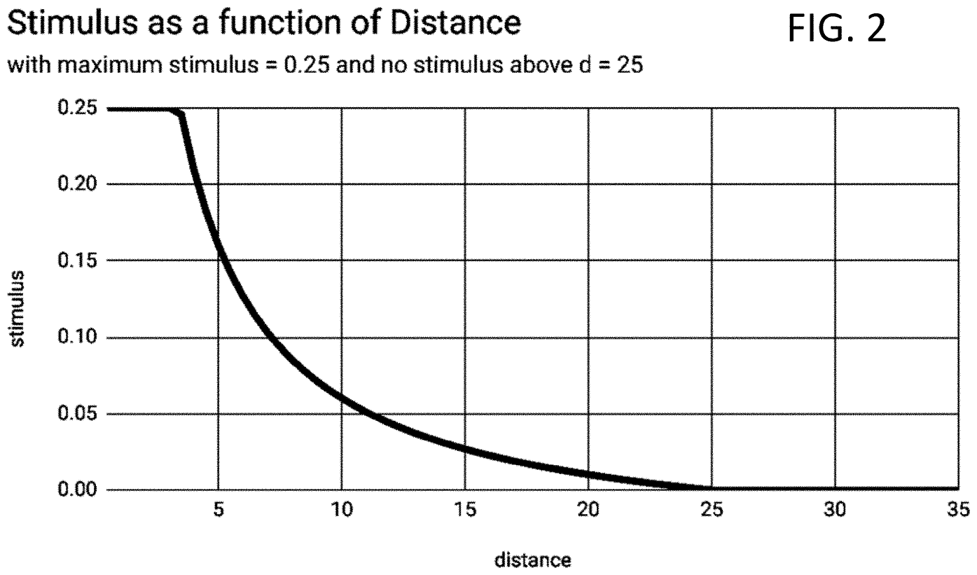

FIG. 2 illustrates a graph of an example stimulus according to the above formula.

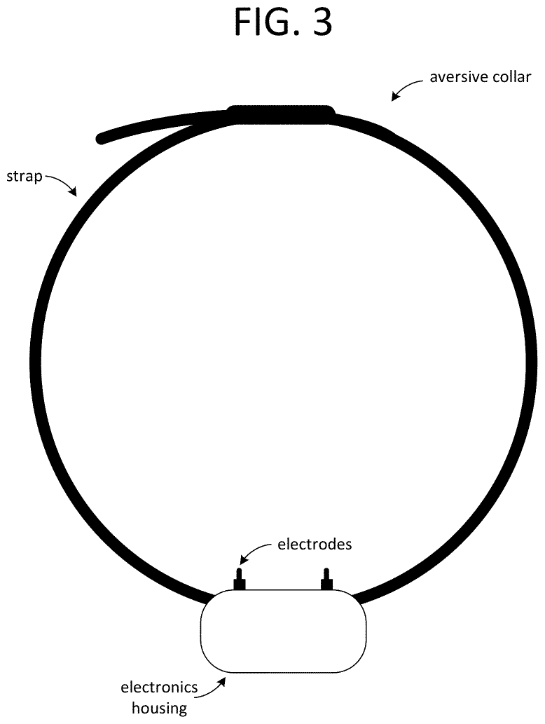

FIG. 3 illustrates a general diagram of an aversive collar in accordance with one embodiment. The collar can include a strap to secure the collar to an animal. An electronics housing can include electrical components necessary to control and deliver an aversive stimulus. The aversive stimulus can be delivered as an electronic shock through, for example, two electrodes positioned on a back of the electronics housing so as to be in contact with the skin of the animal's neck.

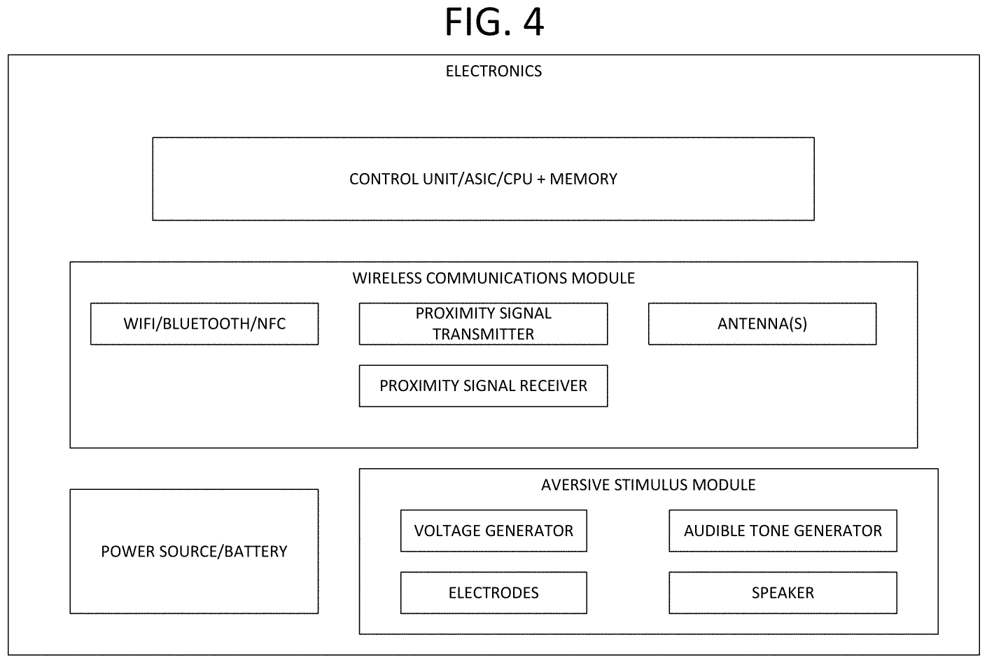

FIG. 4 illustrates a component schematic of electronics of the collar in accordance with one embodiment. The electronics, which can generally be enclosed within or attached to the electronics housing, can include a control unit, a wireless communication module, a power source, and an aversive stimulus module.

The aversive stimulus module can include, for example, a voltage generator and a shock delivery mechanism, such as one or more electrodes. The aversive stimulus module can also or alternative include an electronic audible tone generator and a speaker to deliver the audible tone.

The control unit can be, for example, an application specific integrated circuit (ASIC) or a central processing unit/microprocessor with memory including program instructions.

The wireless communication module can include a proximity signal transmitter and a proximity signal receiver, which can optionally be integrated together in a proximity signal transceiver. The transmitter, receiver, and/or transceiver can include one or more antennae or can be connected to one or more separate antennae for transmission and receipt of radio signals. The proximity signal transmitter/receiver can send out a signal for receipt by other collars and receive signals from other collars to determine proximity of the other collars. The proximity signal receiver can be configured to determine a strength of a received signal, where the strength of the received signal can in turn be used by the control unit to calculate a proximity of an antenna sending the received signal. A transmitted signal can be encoded with a value indicating a strength of the transmission, where the strength of the transmission can be used by a receiving control unit in determining proximity or distance. In one embodiment, each collar can be configured to transmit a unique signal or a signal with a unique identifier so that signals from multiple distant collars do not get additively combined and misinterpreted as a single closer collar.

The wireless communication module can also or alternatively include a Wi-Fi/Bluetooth module and optionally a near field communication (NFC) module, any or all of which can be used to connect to and/or control the collar. For example, an app executing on a mobile device could be used to electronically communicate with and configure or control the collar through any of these wireless communication methods. In one embodiment, the Wi-Fi and/or Bluetooth module can be configured to function as the proximity signal transmitter/receiver. In one embodiment, the wireless communication module can be integrated along with the control unit in a single ASIC.

Upon receiving a signal, the control unit and/or the wireless communication module can process the signal to determine whether the signal is one transmitted by another aversive collar. The determination can be made, for example, based on data encoded into the received signal by the transmitting collar. The data can be encoded using various known techniques for encoding data for transmission by wireless communications (e.g. using a specific frequency, encoding data by modulating a signal, or other means). The data can be or include a particular identifier associated with compatible collars. The data can be or include any of a range of unique identifiers associated with compatible collars. By using a range of identifiers, signals from different collars can be distinguished.

In the case that the signal is determined to have been transmitted by another aversive collar, the control unit can analyze the signal to determine whether the other collar is within a minimum distance. Alternatively the control unit can determine whether the received signal is of a sufficient strength indicative that the other collar is within a certain distance without actually determining a distance. In one embodiment, delivery of an aversive stimulus can be triggered based on signal strength (being indicative of distance) as an alternative to actual determined distance.

Control of the collar, such as by a mobile device, can include various functions. For example, the collar can be configured to be turned off in special circumstances, such as when cattle are being herded or transported in close proximity to each other or when the risk of fighting between animals is low. Various parameters of the collar can be made configurable, such as the level of electrical shock delivered by the electrodes, the distance at which the aversive stimulus first is initiated, the maximum level of stimulus, and/or the rate at which the stimulus increases with decreased distance.

In one embodiment, the collar can also include additional modes of aversive stimuli, such as a tone or audible alarm, which can be made a precursor to an electrical shock when an animal comes within a predefined distance of another.

In one embodiment, the collar or the electronics module can be fitted with a solar panel or array for charging a rechargeable battery.

In one embodiment, the electronics module can be configured with an inertial measurement unit or GPS capability to determine motion. The control unit can be used to take motion of an animal into account when determining whether to deliver an aversive stimulus. For example, it may be the case that a first animal is standing still when another aggressive animal begins to approach, crossing a threshold distance when an aversive stimulus would be provided. In this case it may be desirable to only have the collar of the approaching animal deliver an aversive stimulus while the stationary animal may receive no stimulus at all. Accordingly, the control unit can be configured such that motion or a change in motion, such as an increase in motion, is a necessary condition when delivering or increasing an aversive stimulus.

Further, cessation of motion can also be taken into account, for example, when determining when to cease or decrease delivery of an aversive stimulus. For example, the control unit can be configured to cease delivery of stimulus when a charging animal suddenly stops. If the animal does not retreat, the stimulus can be restarted, possibly gradually, until the animal begins to retreat. Various algorithms, schemes, or heuristics can be configured and tested to determine efficacy and correlation with desired results of decreasing physical confrontations between animals.

The frequency, intensity and/or duration of aversive stimuli as well as combinations of different stimuli such as electric shock and sound can be varied to achieve positive outcomes. By way of example, individual electric shocks can be varied in duration, voltage, and/or frequency. Audible tones can be varied in duration, level, frequency, and the type/nature of sound produced, such as pitch/tone/sound.

In one embodiment, an mobile device app can be configurable to cause the mobile device to produce a proximity signal receivable by aversive collars. The proximity signal received from the mobile device can be treated similarly or identically to signals from other aversive collars. In accordance with this embodiment, a livestock manager who is managing a difficult or dangerous animal can use the mobile device app to turn their mobile device into a collar-like transmitter which can be used to incent the animal to move in a desired direction. As the livestock manager moves toward the collar-wearing animal with mobile device in hand, the animal will receive a stimulus that increases as the manager approaches and the animal will naturally move away. Two or more mobile devices can be used by multiple people to herd an animal in a certain direction. For example two mobile devices can be used (based on maximum radii within which to cause a collar to deliver an aversive stimulus) to create a narrow, stimulus-free cone in the direction the livestock managers want the animal to move. Additional mobile devices held by additional people could be used to create a dynamic virtual and moveable fence that can be used to herd animals.

In an additional embodiment, modified collars can be configured to transmit only a proximity signal, but without an aversive stimulus capability, can be fitted to herding dogs such that as a dog approaches a collared animal, the animal receives an aversive stimulus.

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow.

In the claims, the terms “based upon” and “based on” shall include situations in which a factor is taken into account directly and/or indirectly, and possibly in conjunction with other factors, in producing a result or effect.

1. An aversive collar comprising:
a strap for securing the collar around an animal's neck;
a proximity signal transmitter configured to wirelessly transmit a signal receivable by other aversive collars;
a proximity signal receiver configured to receive signals wirelessly transmitted by proximity signal transmitters of other aversive collars;
an aversive stimulus module configured to deliver an aversive stimulus to the animal; and
control logic configured to:
cause the proximity signal transmitter to transmit the signal receivable by other aversive collars,
identify a signal received by the proximity signal receiver as a signal transmitted by an other aversive collar,
process the received signal to determine that the other aversive collar is within a predetermined proximity, and
in response to at least the determination that the other aversive collar is within a predetermined proximity, cause the aversive stimulus module to deliver an aversive stimulus to the animal.

2. The collar of claim 1, wherein the signal received by the proximity signal receiver is identified as a signal transmitted by the other aversive collar based on data encoded into the received signal.

3. The collar of claim 2, wherein the transmitted signal receivable by other aversive collars is encoded with data that distinguishes the aversive collar from other aversive collars.

4. The collar of claim 1, wherein the proximity signal transmitter and the proximity signal receiver are integrated into a transceiver.

5. The collar of claim 1, wherein the signal is a Wi-Fi signal or a Bluetooth signal.

6. The collar of claim 1, further comprising:
an inertial measurement unit;
wherein the control unit is further configured to:
monitor recent motion of the animal using the inertial measurement unit, and
in response to at least the determination that the other aversive collar is within a predetermined proximity, cause the aversive stimulus module to deliver an aversive stimulus to the animal only if the recent motion of the animal satisfies one or more predefined criteria.

7. The collar of claim 6, wherein the one or more predefined criteria comprise:
the animal is in motion;
the animal has recently initiated motion; and
the animal has recently increased a rate of motion.

8. The collar of claim 1, wherein the control unit is further configured to adjust a level of aversive stimulus delivered based on a level of proximity, wherein a minimum level of aversive stimulus is delivered at the predetermined proximity, and increased levels of aversive stimulus are delivered with increased proximity up to a maximum level of aversive stimulus.

9. The collar of claim 8, further comprising:
an inertial measurement unit;
wherein the control unit is further configured to:
monitor recent motion of the animal using the inertial measurement unit, and
in response to at least a determination that the other aversive collar is becoming closer, cause the aversive stimulus module to deliver an increasing aversive stimulus to the animal only if the recent motion of the animal satisfies one or more predefined criteria.

10. The collar of claim 9, wherein the one or more predefined criteria comprise:
the animal is in motion;
the animal has recently initiated motion; and
the animal has recently increased a rate of motion.

11. The collar of claim 8, further comprising:
an inertial measurement unit;
wherein the control unit is further configured to:
monitor recent motion of the animal using the inertial measurement unit, and
in response to at least a determination that the other aversive collar is not becoming closer, cause the aversive stimulus module to deliver a decreasing aversive stimulus to the animal only if the recent motion of the animal satisfies one or more predefined criteria.

12. The collar of claim 11, wherein the one or more predefined criteria comprise:
the animal is not in motion;
the animal has recently ceased motion; and
the animal has recently decreased a rate of motion.

13. The collar of claim 1, wherein the predetermined proximity is determined based on signal strength of the received signal.

14. The collar of claim 1, wherein the predetermined proximity is represented by a predetermined minimum signal strength of the received signal.

15. The collar of claim 1, wherein the aversive stimulus module comprises an electric shock generator and delivery electrodes.

16. The collar of claim 15, wherein the aversive stimulus module further comprises a sound signal generator and a speaker.

17. The collar of claim 16, wherein the control logic is further configured to:
first deliver an audible alarm aversive stimulus; and
second, after a delay, deliver an electric shock aversive stimulus.

18. The collar of claim 8, wherein the aversive stimulus comprises electric shocks, and a level of aversive stimulus is varied by changing one or more of voltage, duration, and frequency of the electric shocks.

19. The collar of claim 8, wherein the aversive stimulus comprises audible signals, and a level of aversive stimulus is varied by changing one or more of duration, level, frequency, pitch, tone, and sound.

20. A system comprising:
a plurality of aversive collars according to claim 1, fitted to a plurality of animals; and
at least one of:
a mobile device, carried by a human, wherein the mobile device is configured to transmit a signal that each aversive collar interprets as or in a same way as a signal transmitted by another aversive collar; and
a transmitter collar fitted to a dog, wherein the transmitter collar is configured to transmit a signal that each aversive collar interprets as or in a same way as a signal transmitted by another aversive collar.
